(19) United States
(12) Patent Application Publication
(10) Pub. No.: US 2003/0107536 A1
(43) Pub. Date: Jun. 12, 2003

(54) Light emitting circuit for organic electroluminescence element and display device

(75) Inventors: Shinichi Ishizuka, Tsurugashima-shi (JP); Masami Tsuchida, Tsurugashima-shi (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/309,208

(22) Filed: Dec. 4, 2002

(30) Foreign Application Priority Data
Dec. 6, 2001 (JP) 2001-372883

(51) Int. Cl. G09G 3/30

(52) U.S. Cl. 345/76

(57) ABSTRACT

A light emitting circuit and a display device which supply a forward driving current to an organic electroluminescence element in response to generation of a light emit command to cause to light-emit the organic electroluminescence element, and supply a charging current to the organic electroluminescence element after the generation of the light emit command to charge the capacity component of the organic electroluminescence element.

### BACKGROUND OF THE INVENTION

1. Field of the Invention

The present invention relates to a light emitting circuit for an organic electroluminescence element and a display device.

2. Description of the Related Background Art

An electroluminescence element (hereinafter referred to as ‘EL element’), which is a capacitive light emitting element, can be electrically expressed as an equivalent circuit, as shown in FIG. 1. As can be understood from FIG. 1, an element can be substituted by a constitution of a capacity component C and a component E having a diode characteristic coupled in parallel to the capacity component. Therefore, an EL element can be considered to be a capacitive light emitting element. When a light emitting driving DC voltage is applied between the electrodes of the EL element, electric charge is accumulated in the capacity component C. When the voltage across the electrodes exceeds the barrier voltage or the light emission threshold voltage peculiar to the EL element, electric current starts flowing from the electrode (the anode side of the diode component E) to an organic functional layer forming a light emitting layer. As a result, the EL element emits light at light intensity proportional to the current.

The voltage V-current I-luminance L characteristic of the EL element is, as shown in FIG. 2, similar to the characteristic of a diode in that the current I is very small at a voltage lower than the light emission threshold voltage Vth and increases at a voltage higher than the light emission threshold voltage Vth. Further, the current I and the luminance L are nearly proportional to each other. The EL element shows light emitting luminance proportional to the current I which flows in accordance with a driving voltage V when the driving voltage applied to the EL element exceeds the light emission threshold voltage Vth, and shows no light emitting luminance when the driving voltage V applied to the EL element is equal to or lower than the light emission threshold voltage Vth.

A display panel on which a plurality of EL elements are mounted in a matrix shape is already known. A display device that actively drives a display panel with EL elements is mounted with light emitting circuits configured as illustrated in FIG. 3 for respective pixels.

As shown in FIG. 3, the light emitting circuit for a single pixel includes two FETs (Field Effect Transistor) 1 and 2 and a capacitor 3 so as to drive an EL element 5. The gate G of the FET 1 is connected to a scan line Ai supplied with a scan signal, and the source S of the FET 1 is connected to a data line Bj supplied with a data signal. The Drain D of the FET 1 is connected to the gate G of the FET 2 and one terminal of the capacitor 3. The source S of the FET 2 is connected to a common power supply line 6 as well as the other terminal of the capacitor 3. The drain D of the FET 2 is connected to the anode of the EL element 5. The cathode of the EL element 5 is grounded. The earth, to which the power supply line 6 and the cathode of the EL element 5 are connected, is connected to a power source (not shown).

Although the El element 5 is shown in FIG. 3 by a symbol for a diode, it can more exactly be shown in an equivalent circuit as shown in FIG. 1. The same thing can be said for a later-stated EL element 25.

With regard to the operation of the light emitting circuit, first, a scan signal is supplied to the gate G of the FET 1 through the scan line Ai, and then, the FET 1 turns on to pass a current from the source S to the drain D. The current is flowed in accordance with the voltage of a data signal supplied to the source S. The capacitor 3 is charged during the period of the ON-state of the FET 1, and the charged voltage is supplied to the gate G of the FET 2 to turn the FET 2 into the ON-state (active or saturation state). In the ON-state of the FET 2, a driving current flows from the power supply line 6 through the source S and the drain D of the FET 2 and to the EL element 5 to make the EL element 5 emit light. When the supply of the scan signal to the gate G of the FET 1 disappears, the FET 1 turns into an OPEN-state. Then, the voltage of the gate G of the FET 2 is maintained by the accumulated charge in the capacitor 3, whereby the driving current is maintained until a next scanning and the light emission of the EL element 5 is maintained as well.

The light emitting luminance of the EL element 5 is controlled to obtain a display gradation in accordance with image data. Here, either a driving current modulation system, which controls luminance by the level of the driving current for each frame, or a frame modulation system, which controls the driving period in one frame with a constant current driving level, can be applied for luminance control. As shown in FIG. 4, the driving current modulation system uses the FET 1 in an active state in accordance with image data to vary the driving current, whereby luminance is varied for each frame. On the other hand, the frame modulation system, as shown in FIG. 5, divides one frame into a plurality of sub frames of SF1, SF2, SF3, . . . and uses the FET 1 in a saturation state only for the sub frame periods selected in accordance with image data to supply the driving current with a constant level, whereby light is emitted or not in the unit of sub frame.

However, since an EL element has a capacity component as stated above, when the flow of a driving current into the EL element is started, the forward voltage of the EL element gradually increases by charge accumulated in its capacity component. It may take time for the forward voltage to exceed the light emission threshold voltage. Particularly in gradation driving of a driving current modulation system, the driving current is controlled in accordance with the display gradation of a pixel. If the driving current level is low as shown in FIG. 6A, the forward voltage of the EL element gradually increases to exceed the light emission threshold voltage Vth. Accordingly, as shown in FIG. 6B, the EL element emits light only for the last short period of one frame. The light emitting luminance gradually increases and is not constant, and thus it is not allowed to obtain desired luminance.

In addition, even when flowing the driving current with a constant level at the start of supplying the driving current to the EL element, the time required for exceeding the light emission threshold voltage varies in accordance with the quantity of accumulated charge left in the capacity component of the EL element then. Particularly in a frame modulation system, if a large quantity of accumulated charge is left in the capacity component of the EL element, as shown in FIG. 7A, at the time of starting the supply of the driving current, the forward voltage of the EL element is present with a level in accordance with the quantity of accumulated charge, and the voltage starts increasing from this voltage level. Accordingly, it takes a short time for the voltage to exceed the light emission threshold voltage Vth, and the EL element, as shown in FIG. 7B, starts emitting light in a comparatively short time after the start of the supply of the driving current. On the other hand, if a quantity of accumulated charge is hardly left in the capacity component in the EL element, as shown in FIG. 8A, at the time of starting the supply of the driving current, the forward voltage level of the EL element in accordance with the quantity of accumulated charge is nearly zero volts, and the voltage starts increasing from this low voltage level of nearly zero volts. Accordingly, it takes a long time for the voltage to exceed the light emission threshold voltage Vth. The EL element, as shown in FIG. 8B, starts emitting light at a late time after the start of the supply of the driving current. As a result, even when supplying the driving current to the EL element with the same level for the same period of time, the light emitting luminance varies in accordance with the quantity of accumulated charge left in the capacity component of the EL element at the start of supplying the driving current to the EL element. Thus it is not allowed to obtain desired luminance.

### SUMMARY OF THE INVENTION

An object of the present invention is to provide an active driving light emitting circuit, which can provide desired luminance whatever the quantity of accumulated charge of an EL element at the start of supply of a driving current to the EL element is, and also to provide a display device using the circuit.

A light emitting circuit according to the present invention makes an organic electroluminescence element emit light by supplying, in response to generation of a light emit command, a forward driving current to the organic electroluminescence element, the light emitting circuit comprising a charging current supply device which supplies a charging current to the organic electroluminescence element so as to charge a capacity component of the organic electroluminescence element after the generation of the light emit command.

A display device according to the present invention comprises: a display panel having a plurality of drive lines, a plurality of scan lines intersecting with the plurality of drive lines, and a plurality of sets of an organic electroluminescence element and a light emitting circuit of an active driving method, the plurality of sets being arranged at a plurality of intersecting positions by the drive lines and the scan lines, respectively; and a controller which supplies a scan signal to one scan line of the plurality of scan lines in sequence at a specified timing and supplies a data signal to a data line of the plurality of data lines which is associated to at least an organic electroluminescence element to be driven to emit light on the one scan line, wherein the light emitting circuit includes: a switching element which turns on in response to the scan signal to allow the data signal to pass therethrough; a capacitor which is charged by the data signal supplied through the switching element; an EL driving element which activates in accordance with a charged voltage of the capacitor to supply a driving current to the organic electroluminescence element in the same set; and a charging current supply device which supplies a charging current to the organic electroluminescence element in the same set immediately after the supply of the scan signal to charge a capacity component of the organic electroluminescence element in the same set.

### BRIEF DESCRIPTION OF THE DRAWINGS

FIG. 1 illustrates an equivalent circuit of an EL element;

FIG. 2 schematically illustrates the driving voltage-current-light emitting luminance characteristic of the EL element;

FIG. 3 is a diagram illustrating a configuration of a conventional light emitting circuit;

FIG. 4 is the light emitting luminance characteristic diagram of an EL element by a light emitting circuit to which gradation driving of a driving current modulation system is applied;

FIG. 5 is the light emitting luminance characteristic diagram of an EL element by a light emitting circuit to which gradation driving of a frame modulation system is applied;

FIG. 6A and FIG. 6B respectively illustrate the forward voltage and luminance of an EL element in the case of gradation driving of a driving current modulation system;

FIG. 7A and FIG. 7B respectively illustrate the forward voltage and luminance of an EL element in the case of gradation driving of a frame modulation system;

FIG. 8A and FIG. 8B respectively illustrate the forward voltage and luminance of an EL element for gradation driving of a frame modulation system;

FIG. 9 is a block diagram illustrating the configuration of a display device according to the present invention;

FIG. 10 is a circuit diagram illustrating a configuration of a light emitting circuit in the device in FIG. 9;

FIGS. 11A-11E are waveform diagrams illustrating the operation of the light emitting circuit in the FIG. 10;

FIG. 12 is a circuit diagram illustrating another configuration of the light emitting circuit in the device in FIG. 9;

FIG. 13 is a circuit diagram illustrating still another configuration of the light emitting circuit in the device in FIG. 9;

FIG. 14 illustrates a voltage superimposing circuit for supplying a data signal to the light emitting circuit in FIG. 13;

FIGS. 15A-15D are waveform diagrams illustrating the operation of the light emitting circuit in FIG. 13;

FIG. 16 illustrates another voltage superimposing circuit for supplying a data signal to the light emitting circuit in FIG. 13;

FIG. 17 is a circuit diagram illustrating another configuration of the light emitting circuit in the device in FIG. 9;

FIGS. 18A-18E are waveform diagrams illustrating the operation of the light emitting circuit in FIG. 16; and

FIG. 19 is a circuit diagram illustrating another configuration of the light emitting circuit in the device in FIG. 9.

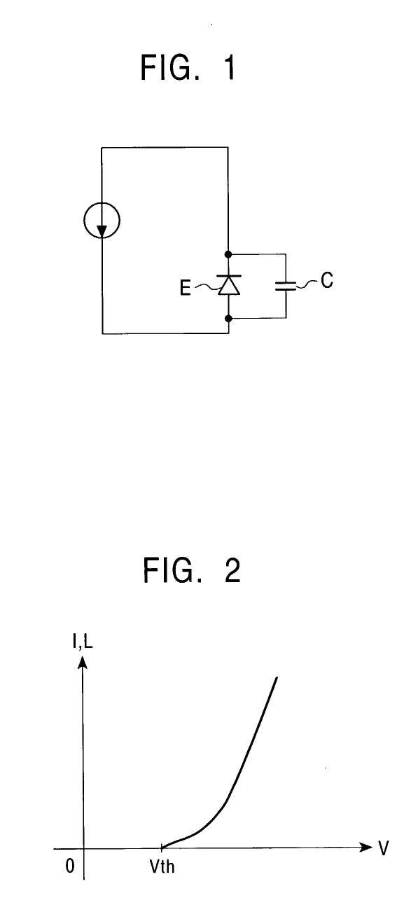

### DETAILED DESCRIPTION OF THE PREFERRED EMBODIMENTS

Preferred embodiments of the invention will be described as follows, with reference to the drawings.

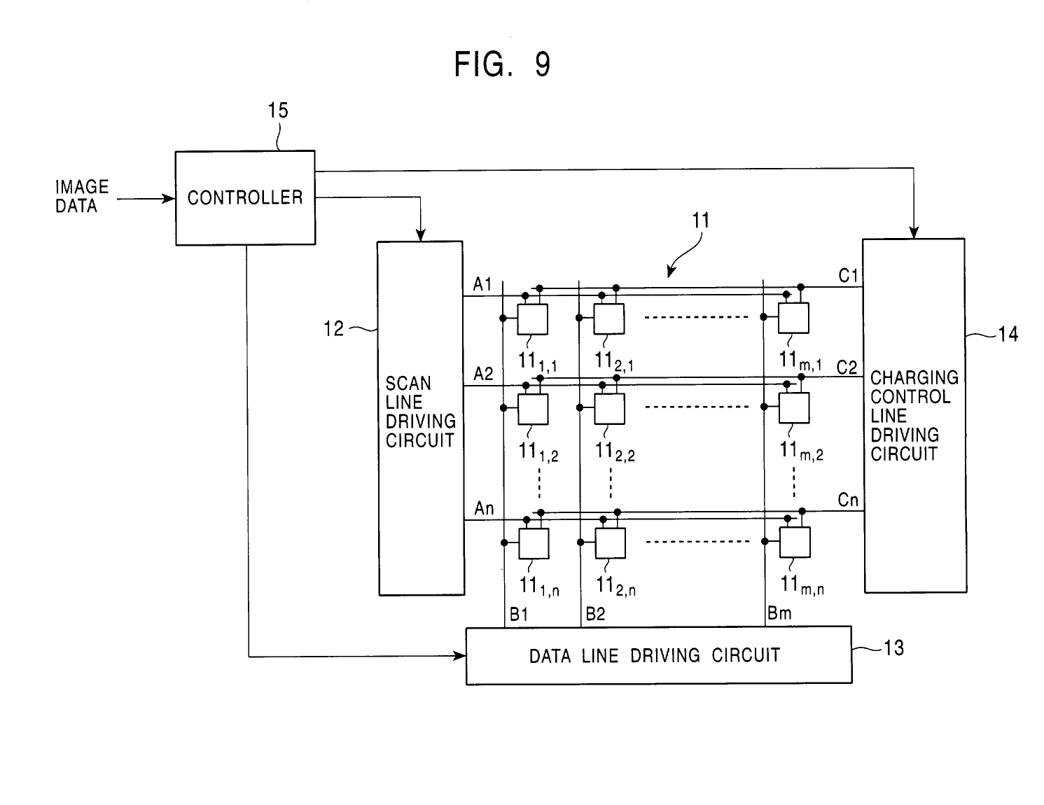

FIG. 9 illustrates a display device using a matrix display panel according to the present invention. The display device includes a display panel 11, a scan line driving circuit 12, a data line driving circuit 13, a charging control line driving circuit 14, and a controller 15.

The display panel 11 is an active matrix type constituted of m×n pixels, and has EL light emitting circuits 11_{1,1}-11_{m,n} for respective pixels as shown in FIG. 9. The EL light emitting circuits 11_{1,1}-11_{m,n} all have the same configuration, and are connected to the scan line driving circuit 12 through scan lines A1-An, to the data line driving circuit 13 through data lines B1-Bm, and to the charging control line driving circuit 14 through charging control lines C1-Cn. The controller 15 generates a scan control signal, a data control signal, and a charging control signal in accordance with input image data. The scan control signal indicates a scan line to be selected and is supplied to the scan line driving circuit 12. The data control signal indicate the data lines corresponding to EL elements to be driven to emit light and is supplied to the data line driving circuit 13. The charging control signal indicates the charging control lines corresponding to the EL elements to be driven to emit light and is supplied to the charging control line driving circuit 14.

The scan line driving circuit 12, the data line driving circuit 13, and the charging control line driving circuit 14, which are not shown specifically, are respectively constituted of a power source and a switch circuit. The scan line driving circuit 12 selects from the scan lines A1-An in sequence for each frame in accordance with a scanning control signal, and supply a scan signal to a selected scan line. The data line driving circuit 13 selects from the data lines B1-Bm in accordance with a light emitting control signal, and supplies a data signal to a selected data line. The charging control driving circuit 14 selects from the charging control lines C1-Cn in accordance with a charging control signal, and supplies a charging signal to a charging control line.

As described above, since the light emitting circuits 11_{1,1}-11_{m,n} all have the same configuration, the configuration of the light emitting circuit 11_{1,1} will be explained as follows.

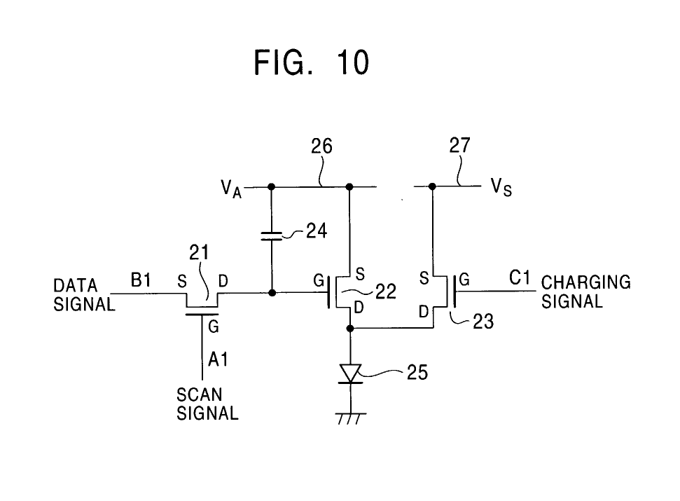

The light emitting circuit 11_{1,1}, as shown in FIG. 10, includes three FETs 21-23 and a capacitor 24 to drive an EL element 25. The gate G of the FET 21 is connected to a scan line A1 to which a scan signal is supplied, and the source S of the FET 21 is connected to a data line B1 to which a data signal is supplied. The drain D of the FET 21 is connected to the gate G of the FET 22 and one terminal of the capacitor 24. The source S of the FET 22 is connected to a common power supply line 26 as well as the other terminal of the capacitor 24. The drain D of the FET 22 is connected to the anode of the EL element 5 as well as the drain D of the FET 23, and the cathode of the EL element 25 is grounded. The source S of the FET 23 is connected to a power supply line 27, and the gate G thereof is connected to a charging control line C1. A specified voltage V_{A} is supplied to the power supply line 26, and a specified voltage V_{S} is supplied to the power supply line 27.

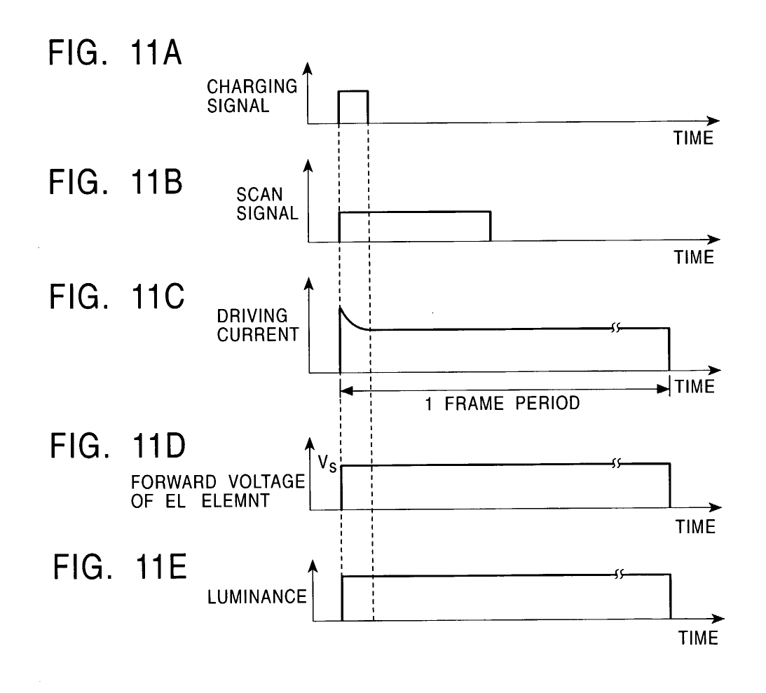

With regard to the operation of the light emitting circuit 11_{1,1} first, a scan signal is supplied to the gate G of the FET 21 through the scan line A1, and at the same time, a charging signal is supplied to the gate G of the FET 23 through the charging control line C1. The scan signal is a pulse voltage having a waveform as shown in FIG. 11B. The charging signal is a pulse voltage having a waveform as shown in FIG. 11A and has a shorter pulse width than that of a scan signal.

The FET 21 is turned on by the supply of the scan signal, and flows a current in accordance with the voltage of the data signal supplied to the source S through the data line B1 from the source S to the drain D. The capacitor 24 is charged, and its voltage is supplied to the gate G of the FET 22 to turn the FET 22 on (saturation or active state). On the other hand, the FET 23 turns on by the supply of the charging signal. Therefore, the FET 22 and the FET 23 almost simultaneously turn on. Consequently, the FET 22 supplies the EL element 25, from the specified Voltage V_{A} with a driving current in accordance with the data signal supplied to the gate G, and the specified voltage V_{S} is applied to the EL element 25 through the source S—drain D of the FET 23. If the EL element 25 has a small quantity of accumulated charge then, a driving current by the specified voltage V_{S} flows to the EL element 25 through the source S—drain D of the FET 23. This driving current flows in order to charge the capacity component of the EL element 25 rapidly. That is, a driving current flows into the EL element 25 as shown in FIG. 11C. As the capacity component of the EL element 25 is charged, the driving current decreases. When the charging signal disappears, the driving current in accordance with the data signal supplied to the gate G of the FET 22 flows into the EL element 25. This driving current by the specified voltage V_{A} flows with a constant level.

By supplying the driving current to the EL element 25 in this way, a voltage is applied to the EL element 25, for example as shown in FIG. 11D, with a constant level, and the light emitting luminance level of the EL element 25 is almost constant, as shown in FIG. 11E, from the start of supplying the driving current to the EL element 25.

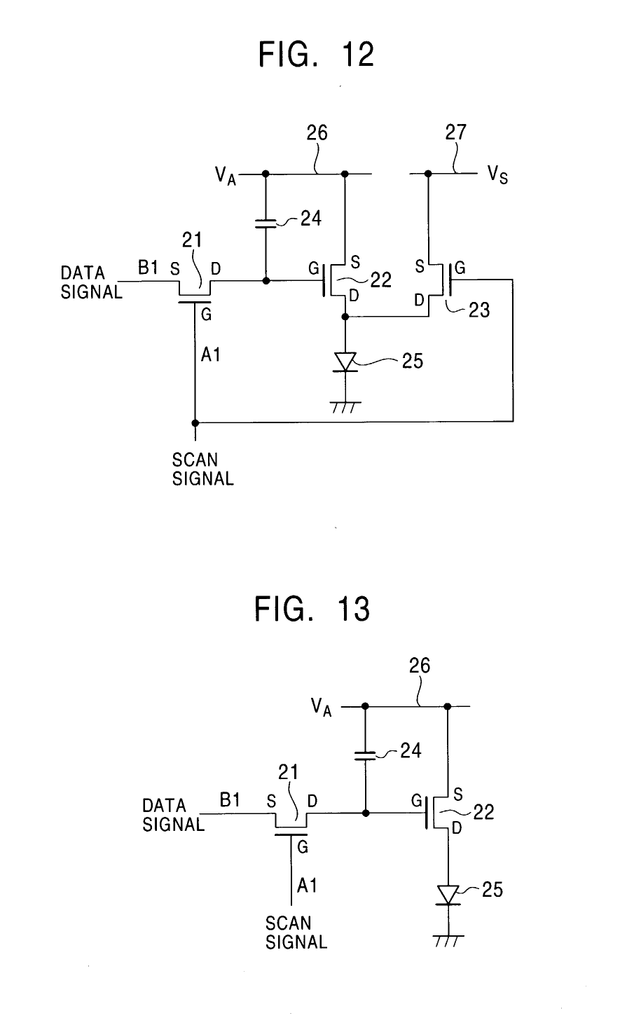

FIG. 12 shows another embodiment of the configuration of the light emitting circuit 11_{1,1}. The light emitting circuit 11_{1,1} in FIG. 12 includes three FETs 21-23, a capacitor 24, and an EL element 25 as in the circuit of FIG. 10. The light emitting circuit 11_{1,1} in FIG. 12 is different from the circuit in FIG. 10 in that, instead of a charging signal, a scan signal is supplied to the gate G of the FET 23 in addition to the gate G of the FET 21 in the circuit 11_{1,1} in FIG. 12. Accordingly, a driving current by the specified voltage V_{S} flows into the EL element 25 through the source S—drain D of the FET 23 during the full period when the scan signal is being supplied, whereby the capacity component of the EL element 25 is rapidly charged. In a display device using the light emitting circuit 11_{1,1} in FIG. 12, neither a charging control line driving circuit 14 nor charging control lines C1-Cn are needed.

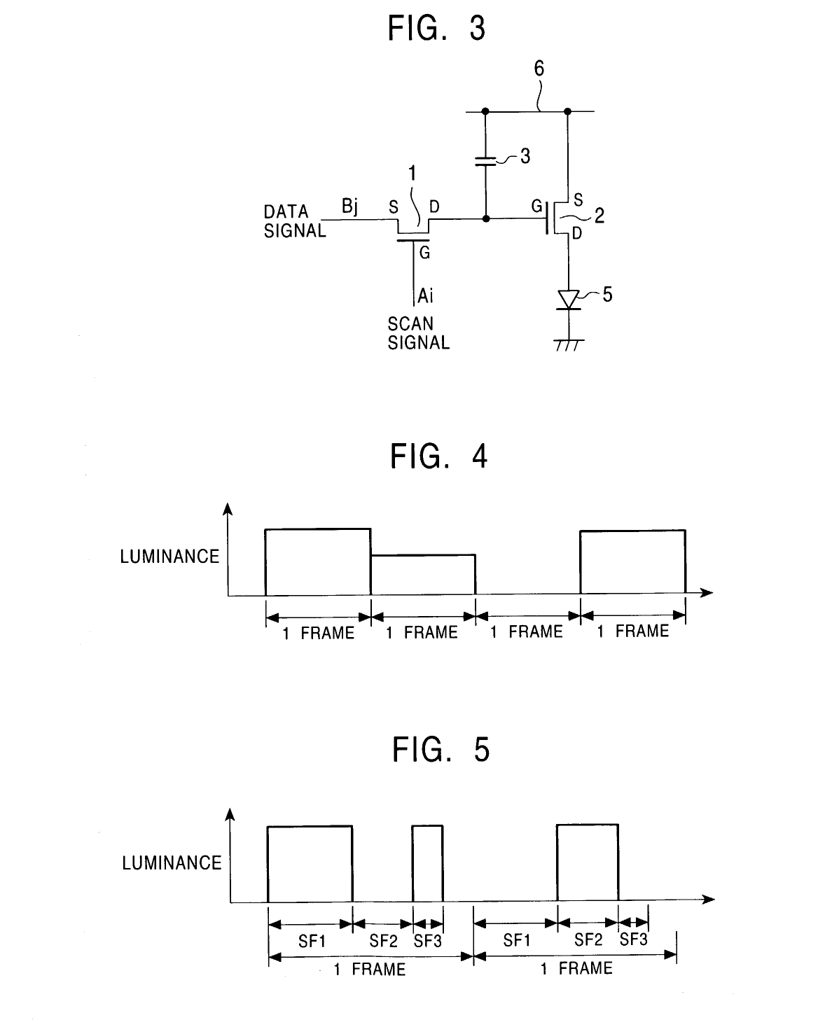

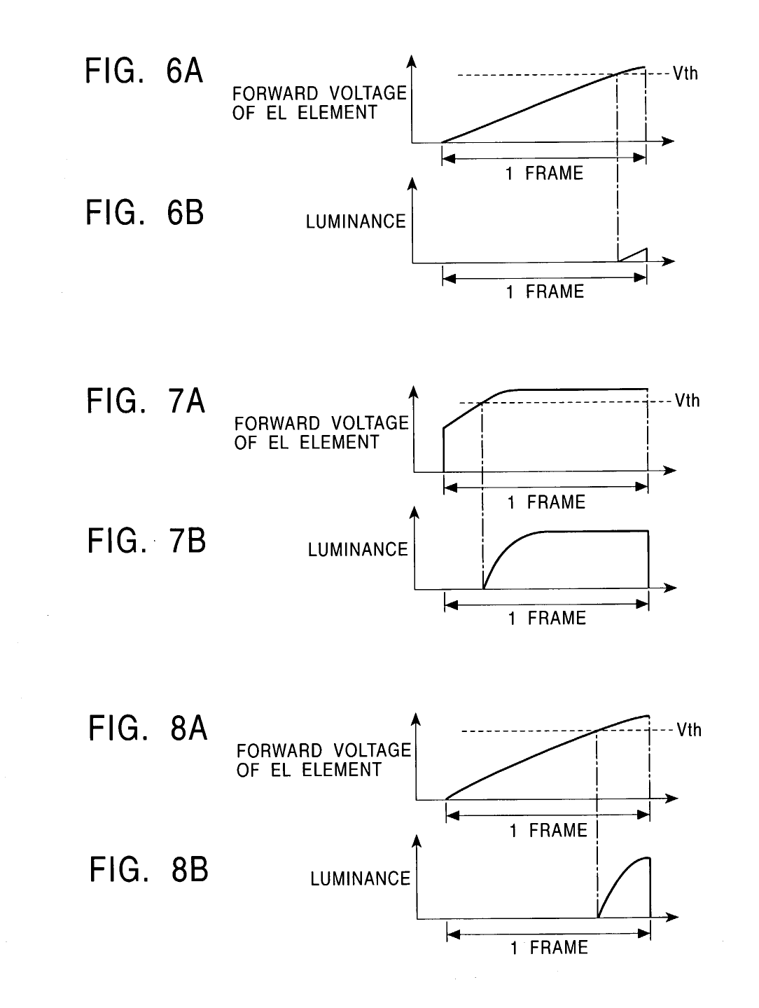

FIG. 13 shows still another embodiment of the configuration of the light emitting circuit 11_{1,1} The circuit 11_{1,1} in FIG. 13 is not provided with the FET 23 that is included in the circuit in FIG. 10, but is provided with the two FETs 21 and 22, capacitor 24, and EL element 25 only. In other words, the light emitting circuit 11_{1,1} in FIG. 13 has the same configuration as one shown in FIG. 3. Also, in a display device using the light emitting circuit 11_{1,1} in FIG. 13, neither a charging control line driving circuit 14 nor charging control lines C1-Cn are needed.

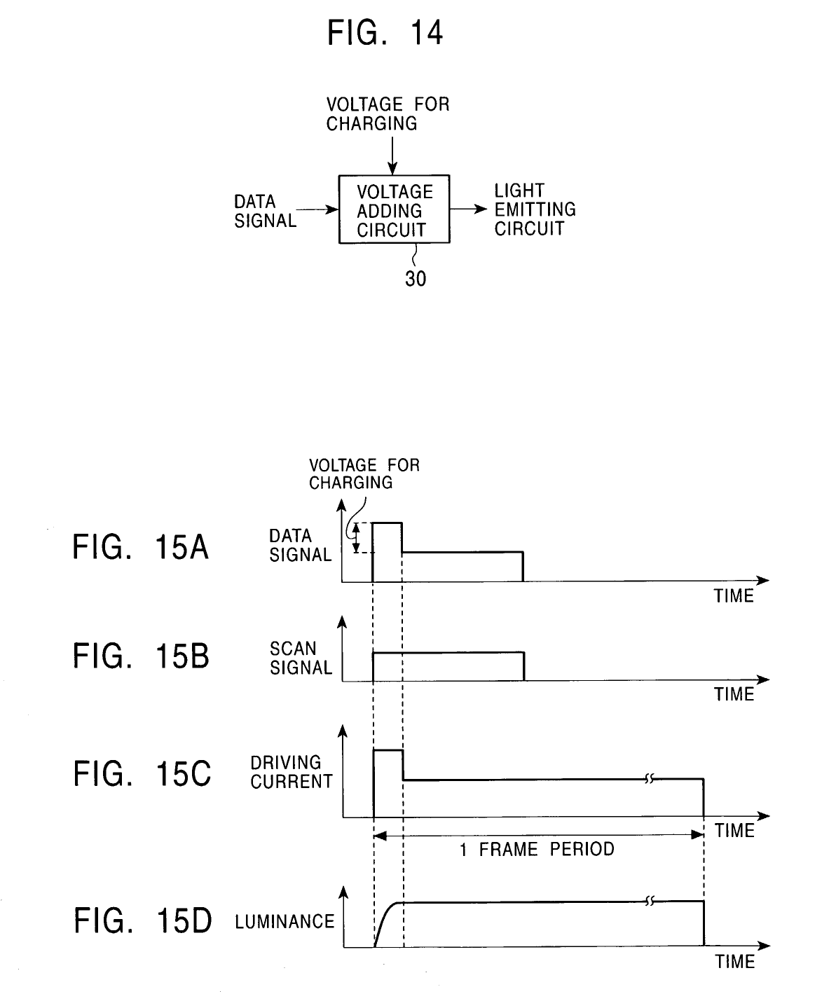

In the data line driving circuit 13 or the controller 15 of the display device, as shown in FIG. 14, a voltage for charging is added to a data signal by a voltage adding circuit 30. This addition is applied to each data signal line. To each of the light emitting circuits 11_{1,1}-11_{m,n} the data signal having a waveform as shown in FIG. 15A is supplied from the data line driving circuit 13. The signal level is higher by the voltage for charging during a specified period from the start of the supply of the data signal, and becomes a normal level after the specified period. The voltage for charging is set in accordance with the gradation of the pixel corresponding to the image data for each of the light emitting circuits.

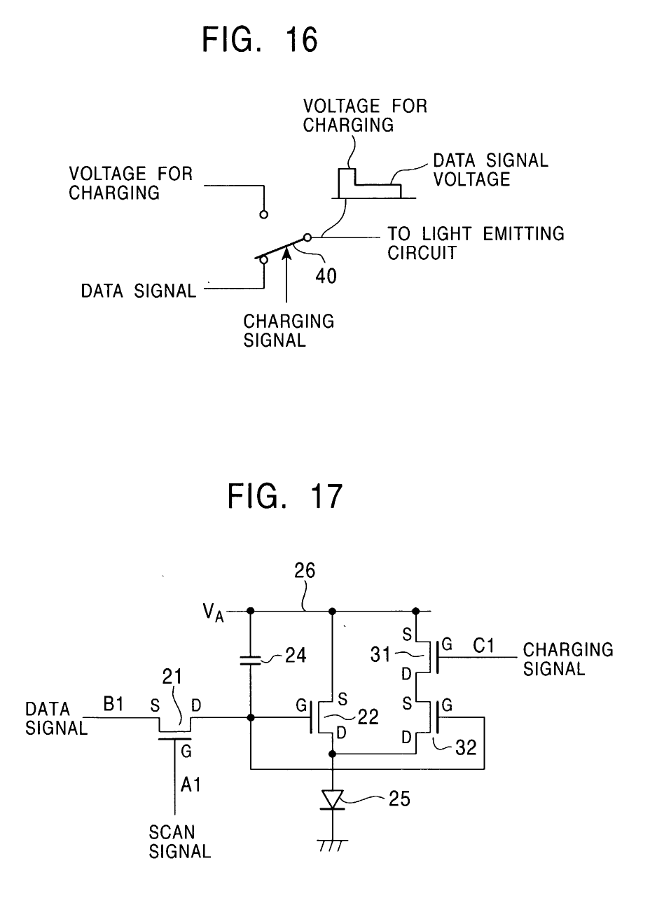

Also, as shown in FIG. 16, the voltage for charging and the data signal may be switched by a changeover switch 40 in accordance with the charging signal.

With regard to the operation of the light emitting circuit 11_{1,1} in FIG. 13, first, the scan signal is supplied to the gate G of the FET 21 through the scan line A1 as shown in FIG. 15B, and then, the FET 21 turns on in accordance with the scan signal to flow a current from the source S to the drain D in accordance with the voltage of the data signal supplied to the source S through the data line B1. The capacitor 24 is charged, and its voltage is supplied to the gate G of the FET 22 to make it an ON-state (saturation or active state). Due to the ON-state of the FET 22, the driving current in accordance with the data signal supplied to the gate G of the FET 22 flows into the EL element 25. Since the signal level is higher by the voltage for charging during a specified period from the start of supply of the data signal, the level of the driving current increases, as shown in FIG. 15C, for a specified period, whereby the capacity component of the EL element 25 is rapidly charged. After the specified period, the level of the data signal returns to a normal signal level. Consequently, the resistance between the source S—drain D of the FET 22 increases, whereby the driving current decreases. Therefore, the light emitting luminance of the EL element 25 increases rapidly from the start of supply of the driving current to the EL element 25 as shown in FIG. 15D, and then maintains almost a constant level.

FIG. 17 shows still another embodiment of the configuration of the light emitting circuit 11_{1,1}. The light emitting circuit 11_{1,1} in FIG. 17 is not provided with the FET 23 that is provided to the circuit in FIG. 10, but provided with the two FETs 21 and 22, capacitor 24, and EL element 25, and still further provided with FETs 31 and 32. The source S of the FET 31 is connected to the power supply line 26, and its drain D is connected to the source S of the FET 32. The drain D of the FET 32 is connected to the anode of the EL element 25 as well as the drain D of the FET 22. The gate G of the FET 31 is connected to the charging control line C1, and the gate G of the FET 32 is connected to the connection line of the gate G of the FET 22. When the FET,32 turns into an ON-state, FET 22 also turns into an ON-state. In this case, the circuit is designed such that the current flowing through the FET 32 is 3 times as high as the current flowing through the FET 22 while both FETs are in the On-state.

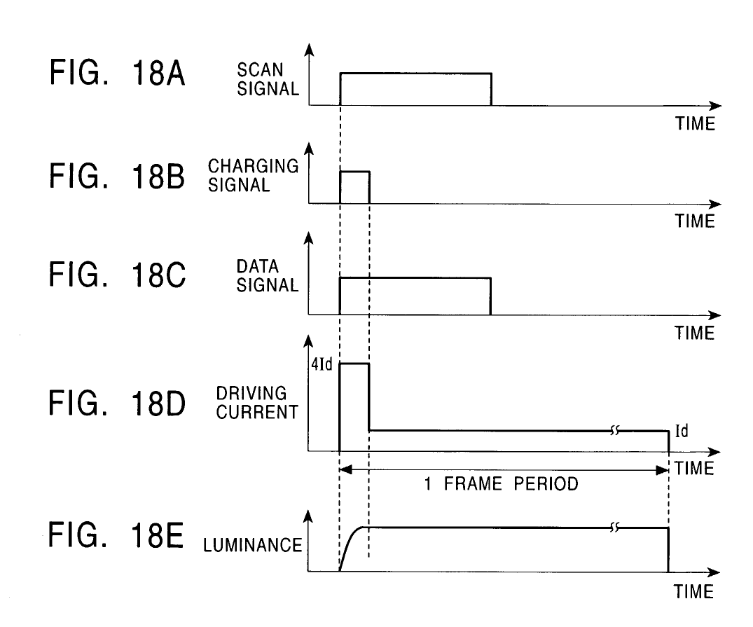

With regard to the operation of the light emitting circuit 11_{1,1} in FIG. 17, when a scan signal is supplied to the gate G of the FET 21 through the scan line A1, a charging signal is simultaneously supplied to the gate G of the FET 32 through the charging control line C1. The scan signal is a pulse voltage having a waveform as shown in FIG. 18A. The charging signal is a pulse voltage having a waveform as shown in FIG. 18B, and for example, has a pulse width shorter than the pulse width of the scan signal.

The FET 21 turns on in response to the supply of the scan signal, and flows a current from the source S to the drain D in accordance with the voltage of the data signal (FIG. 18C) that is supplied to the source S through the data line B1. The capacitor 24 is charged, and its voltage is supplied to the respective gates G of the FETs 22 and 32 to turn the FETs 22 and 32 on. On the other hand, the FET 31 turns on by the supply of the charging signal. Accordingly, the FETs 22, 31, and 32 turn on almost at the same time, and then, the driving current through the source S—drain D of the FET 22 and the driving current through the source S—drain D of the FET 31 and through the source S—drain D of the FET 32 flow into the EL element 25.

As described above, when the FET 32 is in the ON-state, a current flowing into the FET 32 is 3 times as high as the current flowing into the FET 22 which turns on simultaneously. Accordingly, high current, as shown in FIG. 18D, flows into the EL element 25 for the period when the charging signal is supplied. If Id is defined as the driving current through the source S—drain D of the FET22, then the driving current through the source S—drain D of the FET 31 and through the source S—drain D of the FET 32 is added to Id, whereby 4Id flows into the EL element 25. As a result, the capacity component of the EL element 25 is rapidly charged by the driving current of 4Id during the period when this charging signal is supplied.

When the charging signal disappears, the FET 31 turns off, and the supply of the driving current to the EL element 25 through the source S—drain D of the FET 31 and through the source S—drain D of the FET 32 is stopped. As a result, only the driving current of Id by the FET 22 is supplied to the EL element 25. Accordingly, the light emitting luminance of the EL element 25, as shown in FIG. 18E, rapidly increases from the start of the supply of the driving current to the EL element 25, and then maintains almost a constant luminance level.

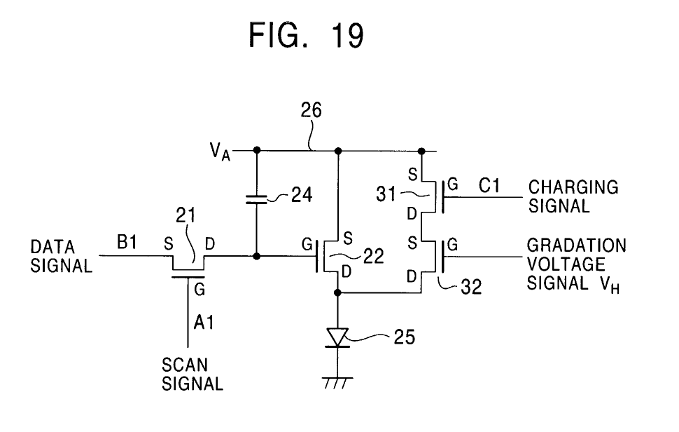

FIG. 19 illustrates yet another embodiment of the configuration of the light emitting circuit 11_{1,1}. The light emitting circuit 11_{1,1} in FIG. 19 is a variation of the circuit configuration in FIG. 17, wherein a voltage signal V_{H} in accordance with the display gradation of each pixel is supplied to the gate G of the FET 32 from the controller 15. The rest of the configuration is the same as that of the circuit in FIG. 17, and the operation of the circuit 11_{1,1} in FIG. 19 is the same as that of the circuit in FIG. 17.

In the embodiments described above, light emitting circuits for a single pixel are explained. In the case of color display, three light emitting circuits of RGB form one pixel.

As stated above, according to the present invention, desired luminance can be obtained whatever the quantity of accumulated charge of the EL element is at the start of the supply of the driving current to the EL element.

This application is based on a Japanese Patent Application No. 2001-372883 which is hereby incorporated by reference.

What is claimed is:

1. A light emitting circuit for making an organic electroluminescence element emit light by supplying, in response to generation of a light emit command, a forward driving current to said organic electroluminescence element, the light emitting circuit comprising:
a charging current supply device which supplies a charging current to said organic electroluminescence element so as to charge a capacity component of said organic electroluminescence element after the generation of said light emit command.

2. A light emitting circuit according to claim 1, wherein said charging current supply device is a voltage applying device which applies a specified voltage to the organic electroluminescence element in a forward direction during a specified period of time after the generation of said light emit command.

3. A light emitting circuit according to claim 2, wherein said specified voltage is set in accordance with light emitting luminance to be obtained by said organic electroluminescence element.

4. A light emitting circuit according to claim 2, wherein said specified voltage is set to a light emission threshold voltage of said organic electroluminescence element.

5. A light emitting circuit according to claim 1, wherein said charging current supply device causes to increase said driving current only during a specified period after the generation of said light emit command.

6. A light emitting circuit according to claim 5, wherein an amount of said driving current to be increased is set in accordance with light emitting luminance to be obtained by said organic electroluminescence element.

7. A display device comprising:
a display panel having a plurality of drive lines, a plurality of scan lines intersecting with said plurality of drive lines, and a plurality of sets of an organic electroluminescence element and a light emitting circuit of an active driving method, said plurality of sets being arranged at a plurality of intersecting positions by said drive lines and said scan lines, respectively; and
a controller which supplies a scan signal to one scan line of said plurality of scan lines in sequence at a specified timing and supplies a data signal to a data line of said plurality of data lines which is associated to at least an organic electroluminescence element to be driven to emit light on said one scan line, wherein
said light emitting circuit includes: a switching element which turns on in response to said scan signal to allow said data signal to pass therethrough; a capacitor which is charged by said data signal supplied through said switching element; an EL driving element which activates in accordance with a charged voltage of said capacitor to supply a driving current to said organic electroluminescence element in the same set; and a charging current supply device which supplies a charging current to said organic electroluminescence element in the same set immediately after the supply of said scan signal to charge a capacity component of said organic electroluminescence element in the same set.

8. A display device according to claim 7, wherein said charging current supply device is a device which applies a specified voltage to said organic electroluminescence element during a period shorter than a time width of said scan signal immediately after the supply of said scan signal.

9. A display device according to claim 7, wherein said charging current supply device is a device which applies a specified voltage to said organic electroluminescence element during a period of a time width of said scan signal immediately after the supply of said scan signal.

10. A display device according to claim 7, wherein said charging current supply device is a current increasing device which increases said driving current during a period shorter than a time width of said scan signal immediately after the supply of said scan signal.

11. A display device according to claim 7, wherein said charging current supply device is a current increasing device which increases said driving current during a period of a time width of said scan signal immediately after the supply of said scan signal.

12. A display device according to claim 7, wherein said current increasing device is a switching element connected with said EL driving element in parallel.

13. A display device according to claim 7, wherein an amount of current increased by said current increasing device varies in accordance with a display gradation.

14. A display device according to claim 7, wherein said charging current supply device is a voltage adding device which increases a voltage level of said data signal during a period shorter than a time width of said scan signal immediately after the supply of said scan signal.

15. A display device according to claim 7, wherein said charging current supply device supplies said data line with a voltage for charging during a period shorter than a time width of said scan signal immediately after the supply of said scan signal.
